(19) United States
(12) Patent Application Publication
(10) Pub. No.: US 2025/0392655 A1
(43) Pub. Date: Dec. 25, 2025

(54) Unified Cellular Data-Plane Headers and Control/Data Sections

(71) Applicant: Apple Inc., Cupertino, CA (US)

(72) Inventors: Amr Abdelrahman Yousef A MOSTAFA, Neuried (DE); Alperen GUNDOGAN, Munich (DE); Christian HOFMANN, Munich (DE); Panagiotis BOTSINIS, Munich (DE); Sameh M ELDESSOK, Munich (DE); Tarik TABET, Carlsbad, CA (US)

(21) Appl. No.: 19/246,086

(22) Filed: Jun. 23, 2025

Related U.S. Application Data
(60) Provisional application No. 63/663,370, filed on Jun. 24, 2024.

(51) Int. Cl. H04L 69/22; H04W 80/02

(52) U.S. Cl. CPC H04L 69/22; H04W 80/02

(57) ABSTRACT

An apparatus configured to receive, based on signals from another apparatus, a transport block comprising a control section, a headers section, and one or more data sections, the transport block having a unified data-plane header and process the transport block based on the unified data-plane header. In some examples, the unified data-plane header comprises a data/control field set to CTRL.

### PRIORITY/INCORPORATION BY REFERENCE

This application claims priority to U.S. Provisional Application Ser. No. 63/663,370 filed on Jun. 24, 2024, and entitled, “Unified Cellular Data-Plane Headers and Control/Data Sections,” the entirety of which is incorporated by reference herein.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

Currently in 3GPP, the different cellular data-plane layers have independent headers (e.g., Service Data Adaptation Protocol (SDAP)/Packet Data Convergence Protocol (PDCP)/Radio Link Control (RLC)/Medium Access Control (MAC)). Further, header information is duplicated in many layers.

### SUMMARY

Some example embodiments are related to an apparatus having processing circuitry configured to receive, based on signals from another apparatus, a transport block comprising a control section, a headers section, and one or more data sections, the transport block having a unified data-plane header; and process the transport block based on the unified data-plane header.

Other example embodiments are related to an apparatus having processing circuitry configured to receive, based on signals from another apparatus, a cellular radio payload comprising a section for control Protocol Data Units (PDUs) section, a headers section, and one or more data sections, wherein the cellular radio payload includes a header that provides information associated with a start and end of each section, wherein each section in the cellular radio payload is to be transmitted with different transmission parameters to separately control a reliability of a transfer for each section; and process the cellular radio payload based on the information in the header.

Further example embodiments are related to an apparatus having processing circuitry configured to receive, based on signals from another apparatus, a transport block comprising a control section, a headers section, and one or more data sections, the transport block having a unified data-plane header that is common for all cellular data-plane layers, wherein the unified data-plane header includes a single data/control field that is used by all cellular data-plane layers; and process the transport block based on the unified data-plane header.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example base station according to various example embodiments.

FIG. 4A shows an example SDAP header according to various example embodiments.

FIG. 4B shows an example PDCP header according to various example embodiments.

FIG. 4C shows an example RLC header according to various example embodiments.

FIG. 4D shows an example MAC header according to various example embodiments.

FIG. 5 shows an example transport block according to various example embodiments.

FIG. 6A shows an example transport block with a unified header according to various example embodiments.

FIG. 6B is a diagram that shows the benefits of switching from a typical transport block to a transport block with a unified header and novel control/data sections according to various example embodiments.

FIG. 7A is a diagram that shows how an example data-plane layer CTRL PDU is handled by lower data-plane layers as a data Service Data Unit (SDU) in various example embodiments.

FIG. 7B is a diagram that shows how an example data-plane layer CTRL PDU is only served by lower data-plane layers in various example embodiments.

FIG. 8A shows an example unified control PDU header according to various example embodiments.

FIG. 8B shows the various fields of an example unified header according to various example embodiments.

FIG. 9A is an example flow diagram of an example current method of preparing an example CTRL PDU according to various example embodiments.

FIG. 9B is an example flow diagram of an example novel method of preparing an example CTRL PDU utilizing a unified CTRL PDU header according to various example embodiments.

FIG. 10A shows a flow diagram for generating a new example buffer status report according to various example embodiments.

FIG. 10B shows an example new buffer status report according to various example embodiments.

FIG. 11 shows a flow diagram for an example method of prioritizing CTRL PDUs on the Tx side according to various example embodiments.

FIG. 12A shows a flow diagram that illustrates an example method of processing CTRL SDUs on the receiver (Rx) side according to various example embodiments.

FIG. 12B shows a flow diagram that illustrates an example method of processing CTRL SDUs on the receiver (Rx) side utilizing a unified header according to various example embodiments.

FIG. 13A shows an example of how various data-plane layers handle various types of PDUs according to various example embodiments.

FIG. 13B shows an example of how various data-plane layers handle various types of PDUs via novel Control Radio Bearers (CRBs) according to various example embodiments.

FIG. 14 shows a flow diagram of an example method using example Control Radio Bearers (CRBs) on the Tx side to allow the application of cellular data-plane services provided by a higher data-plane layer on control SDUs generated by a lower data-plane layer according to various example embodiments.

FIG. 15 shows a flow diagram of an example method of using example control radio bearers (CRBs) on the receiver (Rx) side to provide increased security for data transmission according to various example embodiments.

FIG. 16 is a diagram that shows an example cellular radio payload, such as a MAC PDU, according to various example embodiments.

FIG. 17 shows an example multi-section cellular radio payload according to various example embodiments. FIG. 17 shows an example multi-section cellular radio payload according to various example embodiments.

FIG. 18 is a flow diagram of an example method of creating and using a novel multi-section cellular radio payload such that data may be transmitted with different reliability and or priority according to various example embodiments.

FIG. 19 is a flow diagram that illustrates an example method of processing a received data transfer of a novel multi-section cellular radio payload according to various example embodiments.

FIG. 20 shows a diagram illustrating an example method of only certain parts of an example cellular payload needing to be retransmitted based on the successfully scheduled section(s) according to various example embodiments.

FIG. 21 shows a flow diagram for an example method for retransmitting only certain data in an example cellular radio payload that is associated with high priority Radio Bearers according to various example embodiments.

FIG. 22 shows a diagram that illustrates how an example network may dynamically skip or reduce the number of retransmissions for an example cellular radio payload based on information in successfully delivered sections of the cellular radio payload according to various example embodiments.

FIG. 23A shows a diagram that illustrates how an example UE may indicate to a network the importance of a certain radio payload for the uplink transmission according to various example embodiments.

FIG. 23B is an example flow diagram that illustrates how an example UE may indicate to a network the importance of a certain radio payload for the downlink transmission according to various example embodiments.

FIG. 24A shows an example cellular PDU where header fields are duplicated for data-plane services in different layers according to various example embodiments.

FIG. 24B shows an example unified header that is common across all cellular data-plane layer according to various example embodiments.

FIG. 24C shows an example unified header for data Protocol Data Units (PDUs) according to various example embodiments.

FIG. 25 is a flow diagram that illustrates an example method using 5G data-plane layers with a unified data-plane header according to various example embodiments.

FIG. 26A is a flow diagram that shows the Tx flow using an example unified control PDUs header according to various example embodiments.

FIG. 26B is a flow diagram that shows the Rx flow using an example unified control PDUs header according to various example embodiments.

### DETAILED DESCRIPTION

The example embodiments may be further understood with reference to the following description and the related appended drawings, wherein like elements are provided with the same reference numerals. The example embodiments relate to wireless communication devices, and in particular relate to methods and devices using unified cellular data-plane headers and novel control/data sections.

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate type of electronic component.

The example embodiments are also described with regard to a fifth generation (5G) New Radio (NR) network and a next generation node B (gNB). However, reference to a 5G NR network and a gNB is merely provided for illustrative purposes. The example embodiments may be utilized with any appropriate type of network (e.g., 5G-Advanced network, 6G network, etc.) and base station.

The UE may perform measurements on one or more neighbor cells using a specific downlink reference signal, e.g., a signal synchronization block (SSB) or a channel state information (CSI)-reference signal (RS). The measurements may be based on SSB, CSI-RS or any other appropriate downlink resource. The measurement metric may be L1-reference signal received power (RSRP), L1-signal interference-to-noise ratio (SINR), L1-reference signal received quality (RSRQ) or any other appropriate type of metric. However, any reference to a specific type of measurement, reference signal or metric is merely provided for illustrative purposes. The example embodiments may apply to any appropriate type of measurement, reference signal or metric.

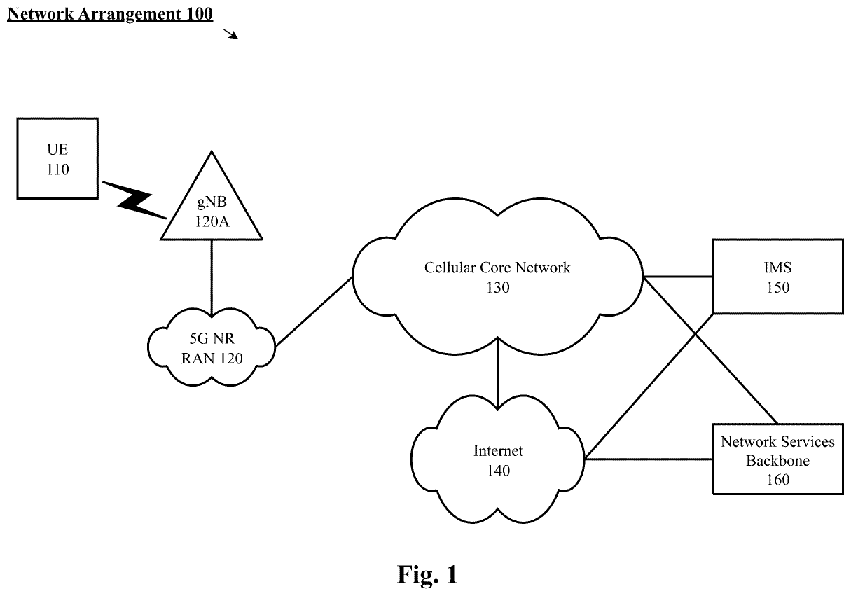

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, phablets, embedded devices, wearables, Internet of Things (IoT) devices, etc. An actual network arrangement may include any number of UEs being used by any number of users. Thus, the example of a single UE 110 is merely provided for illustrative purposes.

The UE 110 may be configured to communicate with one or more networks. In the example of the network arrangement 100, the network with which the UE 110 may wirelessly communicate is a 5G NR radio access network (RAN) 120. However, the UE 110 may also communicate with other types of networks (e.g., sixth generation (6G) RAN, 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the example embodiments, the UE 110 may establish a connection with the 5G NR RAN 120. Therefore, the UE 110 may have at least a 5G NR chipset to communicate with the 5G NR RAN 120.

The 5G NR RAN 120 may be a portion of a cellular network that may be deployed by a network carrier (e.g., Verizon, AT&T, T-Mobile, etc.). The 5G NR RAN 120 may include base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. As used herein, the term “base station,” “access node,” “access point,” or the like may describe equipment that provides the radio baseband functions for data and/or voice connectivity between a network and one or more users. These access nodes may be referred to as BS, qNBs, RAN nodes, eNBs, NodeBs, RSUS, TRxPs or TRPs, and so forth, and may comprise ground stations (e.g., terrestrial access points) or satellite stations providing coverage within a geographic area (e.g., a cell). In fact, in some embodiments, a UE, such as UE 110 described herein, may function as an access point.

In the network arrangement 100, the 5G NR RAN 120 deploys a gNB 120A. The gNB 120A may be configured with multiple TRPs. Each TRP may represent one or more components configured to transmit and/or receive a signal. In some embodiments, multiple TRPs may be deployed locally at the gNB 120A. In other embodiments, multiple TRPs may be distributed at different locations and connected to the gNB 120A via a backhaul connection. For example, multiple small cells may be deployed at different locations and connected to the gNB 120A. However, these examples are merely provided for illustrative purposes. TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam.

Any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer to an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

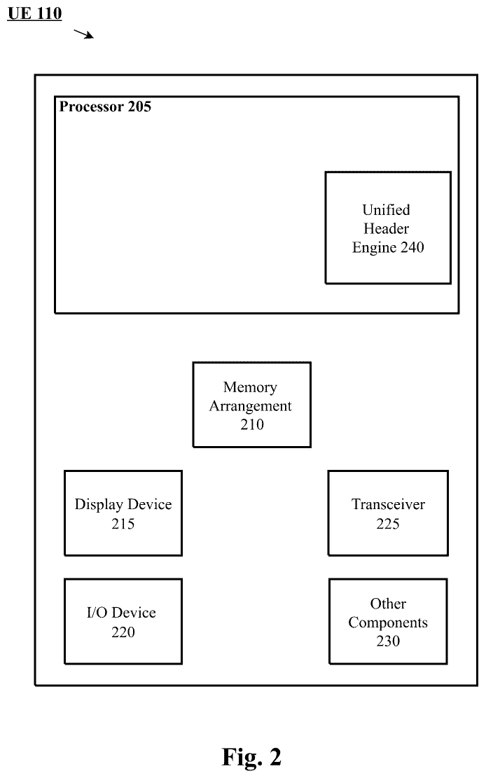

FIG. 2 shows an example UE 110 according to various example embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a Unified Header engine 240. The Unified Header engine 240 may perform various operations related to the creation and use of a unified data-plane header, such as may be used when the UE needs to transfer a data-plane layer control SDU. For example, the unified header engine 240 may use a unified control PDU header to serve a CTRL PDU on a radio bearer (RB) on which a SDU was generated. The Unified Header engine 240 may maintain a separate queue for the CTRL data, based on which the UE reports to the network the amount of pending CTRL data on a certain RB or group of RBs, and the UE may prioritize the serving of CTRL PDUs versus data PDUs. The UE may set the CTRL SDU ID in the unified header, where the CTRL SDU ID is unique across all cellular data-plane layers. When an assignment is received, the UE 110 may prioritize serving the CTRL SDUs across all RBs versus Data SDUs.

The above referenced engine 240 being one or more applications (e.g., a program) executed by the processor 205 is merely provided for illustrative purposes. The functionality associated with the engine 240 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

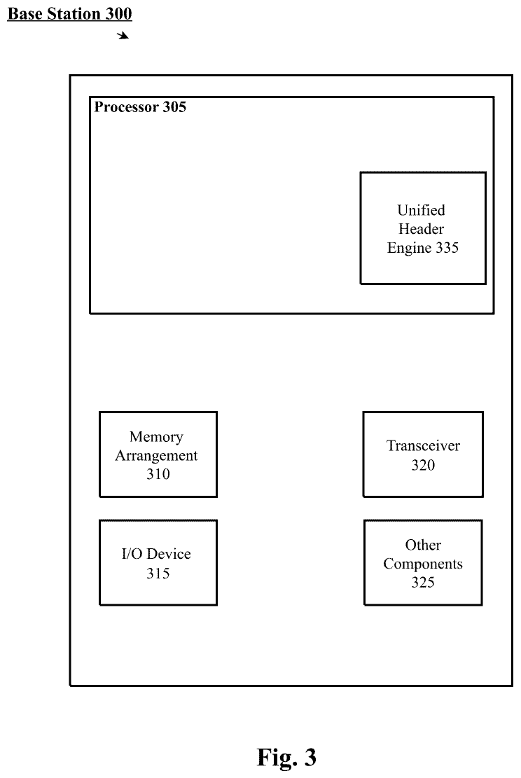

FIG. 3 shows an example base station 300 according to various example embodiments. The base station 300 may represent the gNB 120A or any other type of access node through which the UE 110 may establish a connection and manage network operations. As used herein, the term “base station” may also refer to an “access node,” “access point,” or the like and may describe equipment that provides the radio baseband functions for data and/or voice connectivity between a network and one or more users. These base stations and access nodes may be referred to as BS, qNB s, RAN nodes, eNBs, NodeBs, RSUs, TRxPs or TRPs, and so forth, and may comprise ground stations (e.g., terrestrial access points) or satellite stations providing coverage within a geographic area (e.g., a cell).

The base station 300 may include a processor 305, a memory arrangement 310, an input/output (I/O) device 315, a transceiver 320, multiple TRPs 330 and other components 325. The other components 325 may include, for example, an audio input device, an audio output device, a battery, a data acquisition device, ports to electrically connect the base station 300 to other electronic devices and/or power sources, TxRUs, transceiver chains, antenna elements, antenna panels, etc.

As indicated above, in some scenarios, the multiple TRPs 330 may be deployed locally at the base station 300. In other scenarios, one or more of the multiple TRPs 330 may be deployed at physical locations remote from the base station 300 and connected to the base station via a backhaul connection. The base station 300 may be configured to control the multiple TRPs 330 and perform operations such as, but not limited to, assigning resources, configuring reference signals, implementing beam management techniques, etc.

The processor 305 may be configured to execute a plurality of engines for the base station 300. For example, the engines may include a Unified Header engine 335. The Unified Header Engine 335 may perform various operations related to the creation and use of a unified data-plane header, such as may be used when the base station needs to transfer a data-plane layer control SDU. For example, the unified header engine 335 may use a unified control PDU header to serve a CTRL PDU on a radio bearer (RB) on which a SDU was generated. The Unified Header engine 335 may maintain a separate queue for the CTRL data, based on reports received from a UE reporting the amount of pending CTRL data on a certain RB or group of RBs, and the base station may prioritize the serving of CTRL PDUs versus data PDUs. The base station via the Unified Header Engine 335, may set the CTRL SDU ID in the unified header, where the CTRL SDU ID is unique across all cellular data-plane layers. When an assignment is received, the base station 300 may prioritize serving the CTRL SDUs across all RBs versus Data SDUs.

The base station 300, via the Unified Header Engine 335, may also configure a UE with one or more Control Radio Bearers, and for each CRB, may specify the CTRL SDUs that shall be transferred via this CRB. For example, the base station 300 may configure the UE to send Carrier Aggregation MAC CE via a Control Radio Bearer.

The above noted engine 335 being one or more applications (e.g., a program) executed by the processor 305 is only an example. The functionality associated with the engine 335 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The example embodiments may be implemented in any of these or other configurations of a base station.

The memory 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UEs in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

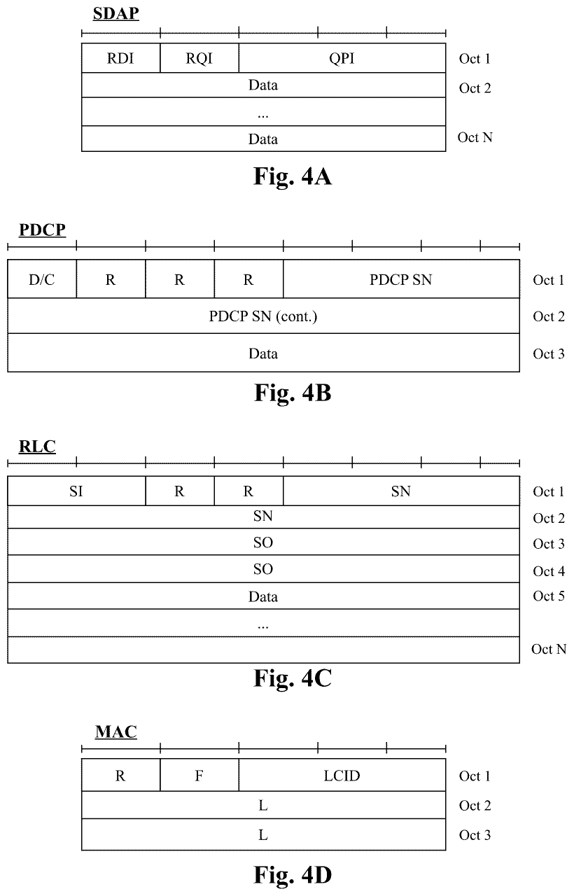

As previously mentioned, currently in 3GPP, the different cellular data-plane layers have independent headers (e.g., SDAP/PDCP/RLC/MAC), as seen in FIGS. 4A-4D. FIG. 4A shows an example SDAP header according to various example embodiments. FIG. 4B shows an example PDCP header according to various example embodiments. FIG. 4C shows an example RLC header according to various example embodiments. FIG. 4D shows an example MAC header according to various example embodiments.

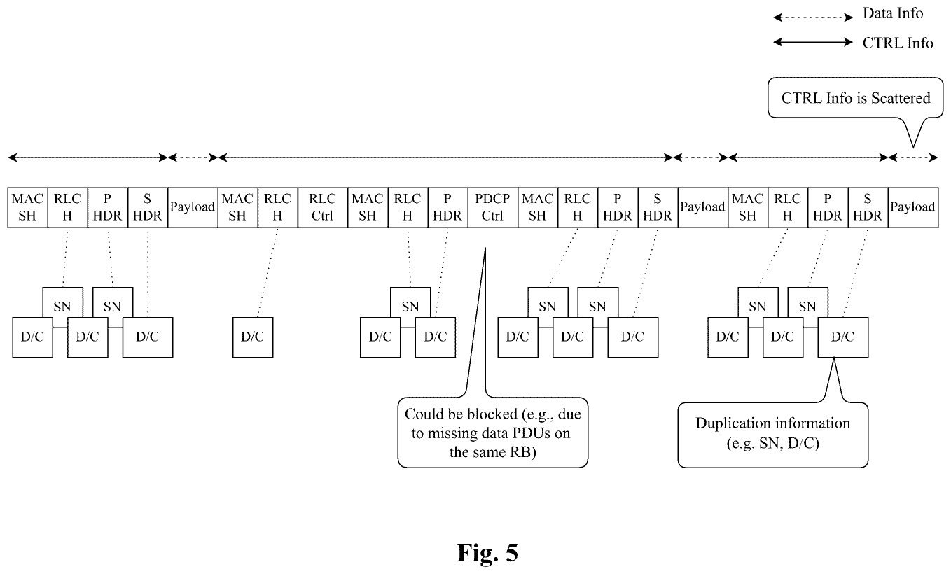

In addition, as seen in FIG. 5, control information and header information is scattered within the transport block (TB). FIG. 5 shows an example transport block according to various example embodiments. Higher layer control information blockage may also be an issue, as seen in FIG. 5. Since control protocol data units (PDUs) are encapsulated in lower layer packets, they cannot be decomposed and prioritized without prior decoding steps per other layers. For example, PDCP Ctrl may only be decoded after RLC successful RLC processing.

Further, header information is duplicated in many layers, as seen in FIG. 5. This may have the effect of limiting the over-the-air efficiency and adding decoding and windowing complexity on many layers. For example, adding security protection in MAC requires additional MAC Sequence Numbers (SNs), resulting in further increasing duplication.

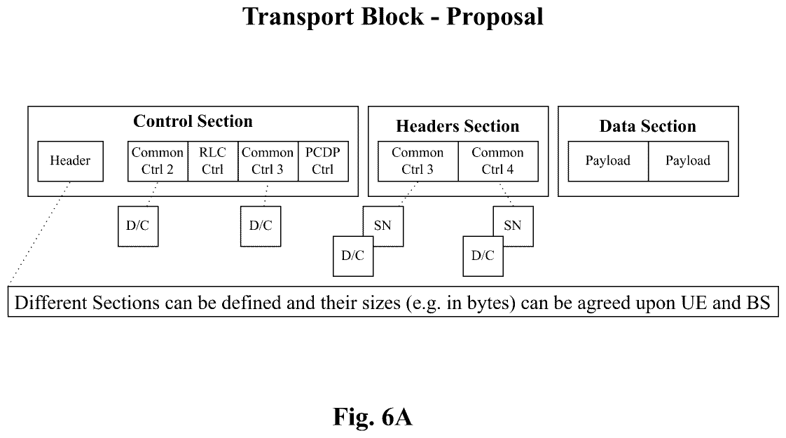

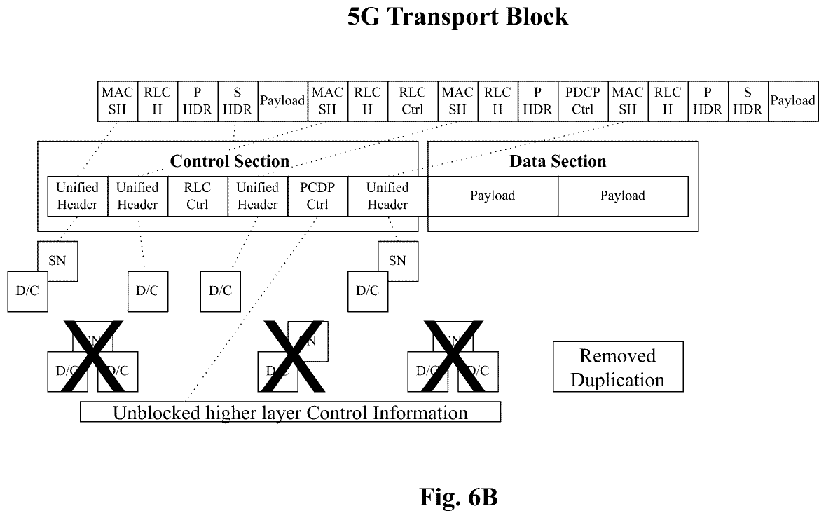

According to certain aspects of this disclosure, a variety of approaches may be considered to address the problems discussed above. In one embodiment, a unified cellular data-plane header is proposed. FIG. 6A shows an example transport block with a unified header according to various example embodiments. In addition, novel control/data sections are proposed, as seen in FIG. 6A. By re-organizing the whole TB block to optimize the control, header and data sections may address the issues described above. Different sections may be defined and their sizes (e.g., number of bytes) may be agreed upon by an example UE and an example base station (gNB). Further details are addressed later.

The benefits of re-organizing the whole TB block to optimize the control, header and data sections and implement a unified data-plane header may include one of more of the following. TB sections may be processed (decoded) differently on the PHY level. Some sections that are more important may be transmitted more robustly (e.g., different MCS). Upon TB reception, the Control Section may be processed (decoded) in a central place (e.g., in RX MAC), even though the TB is not yet fully received since it is not scattered across the TB. In addition, Control Section information may be utilized for cross layer prioritization, e.g., PDCP Control PDUs may directly be forwarded to PDCP without RLC dependency. Further, common L2 header fields may be used to reduce the header overhead, e.g., a SN field that is common for PDCP and RLC.

For example, using the unified header and the novel control and data sections, as seen in FIG. 6B, may provide certain benefits. FIG. 6B is a diagram that shows the benefits of switching from a typical transport block to a transport block with a unified header and novel control/data sections according to various example embodiments. As seen in FIG. 6B, the novel transport block may unblock higher layer control information and remove duplicated information.

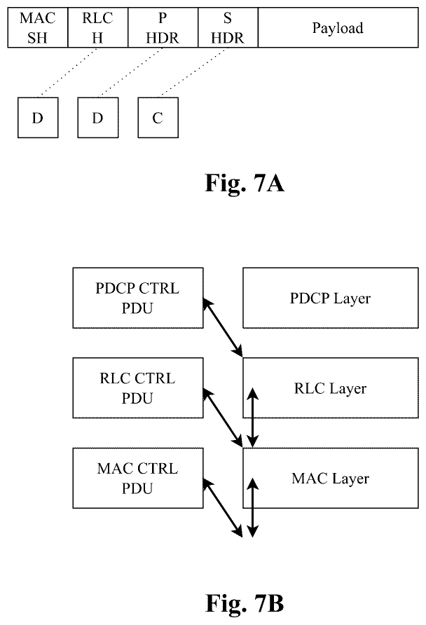

Before providing details on the novel unified data-plane header, more details will be provided on the issues faced when using the current 3GPP headers. In the current 3GPP protocol, a data-plane layer CTRL PDU is handled by lower data-plane layers as data SDU, as seen in FIG. 7A. FIG. 7A is a diagram that shows how example data-plane layer CTRL PDU is handled by lower data-plane layers as data SDU in various example embodiments. This may cause at least four issues (issues A-D discussed below).

Issue A—The cellular network does not know the number of bytes pending for control SDUs on UE handled by lower layers as Data SDUs. Using this information, the cellular network may provide one or more uplink (UL) assignment to the UE with high reliability transmission parameters that is sufficient to only transfer the pending data-plane layers CTRL data. If the cellular network knew the number of bytes pending for control SDUs for a UE handled by lower layers as Data SDUs, reliable and quick delivery of the data-plane layers control data would have advantages like quick delivery of RLC status and the PDU may avoid wasting radio resources in re-sending RLC PDUs that were successfully received.

Issue B—It is not possible to prioritize CTRL SDUS versus Data SDUs of other layers or other radio bearers (RBs). For example, it is not possible to prioritize the transfer of an RLC Status PDU on RB #x versus an RLC DATA PDU on RB #y where both RBU #x and RB #y have the same priority. In addition, it is not possible to prioritize the hybrid Automatic Repeat Request (HARQ) re-transmissions on an HARQ process buffer having higher data-plane layer CTRL PDUS VS HARQ process having only Data PDUs.

Issue C—The processing of CTRL SDUs is delayed due to missing data SDUs on lower layers. For example, SDAP CTRL PDU processing could be delayed due to missing of Data PDUs on the same Radio Bearer.

In addition, since a data-plane layer CTRL PDU is only served by lower data-plane layers, as seen in FIG. 7B, additional issue (issue D) may arise. FIG. 7B is a diagram that shows how an example data-plane layer CTRL PDU is only served by lower data-plane layers in various example embodiments.

Issue D—Today, Ctrl PDUs of a certain data-plane layer may only utilize data-plane services provided by lower layers. For example, RLC Status PDU or a MAC CE security protection is not possible since security protection is provided by higher data-plane layer which is PDCP.

To summarize, in the current approach, each data-plane layer has its own structure of CTRL PDUs and is represented in lower data-plane layers as a data SDU, and thus issues A, B, and C as discussed above may arise. Further, since lower layers CTRL SDUs are not processed by higher data-plane layers, issue D may be present.

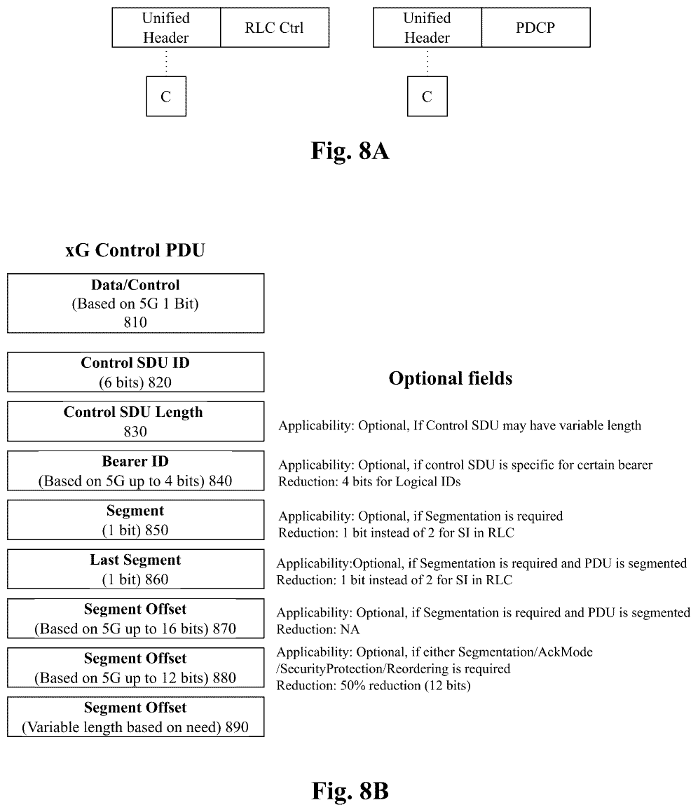

To address these issues, a novel unified cellular data-plane header is proposed. FIG. 8A shows an example unified control PDU header according to various example embodiments.

When a UE or cellular network needs to transfer a data-plane layer control SDU, then the UE or cellular network may create a unified header as seen in FIG. 8A. FIG. 8B shows the various fields of an example unified header according to various example embodiments. The unified control PDU header may have the following information: Data/Control field 810, set to CTRL. In one embodiment, the data/control field 810 may be based on a 5G one (1) bit. The unified control PDU header may also include a CTRL SDU ID field 820. In one example embodiment, the CTRL SDU ID field 820 is six (6) bits. The CTRL SDU ID field 820 may be set to the corresponding data-plane layer CTRL SDU ID that is unique across all data-plane layers. If the CTRL SDU has a variable length, then a Control SDU header length field 830 may be included. The unified control PDU header may also include a bearer ID field 840, if the control SDU is specific for a certain radio bearer. In one embodiment, the bearer ID field 840 may be up to four (4) bits.

If the CTRL SDU could be segmented, then the unified control PDU header may also include segmentation header fields, such as: Segment ID field 850, which may be one (1) bit in certain embodiments; Last Segment field 860, which may be one (1) bit in certain embodiments; and Segment Offset field 870, which may be up to 16 bits in one embodiment. If the CTRL SDU requires any data-plane services such as Security Protection/Order Delivery/Segmentation/Error Recovery (e.g., via ARQ)/Duplication Detection, then a sequence number field 880 may be included, which may be up to 12 bits in one embodiment. Fields 830-880 may be optional fields.

The unified control PDU header may also include Control SDU field 890, which may have a variable length based on need.

Two example methods may be used for serving data-plane layers control SDUs. In the first method, the data-plane layers control SDUs may be served via the Radio Bearer for which the control SDU is generated. This may address issues A/B/C problems discussed above. In the second method, the data-plane layers control SDUs may be served via a separate Radio Bearer. This may address issues A/B/C/D discussed above.

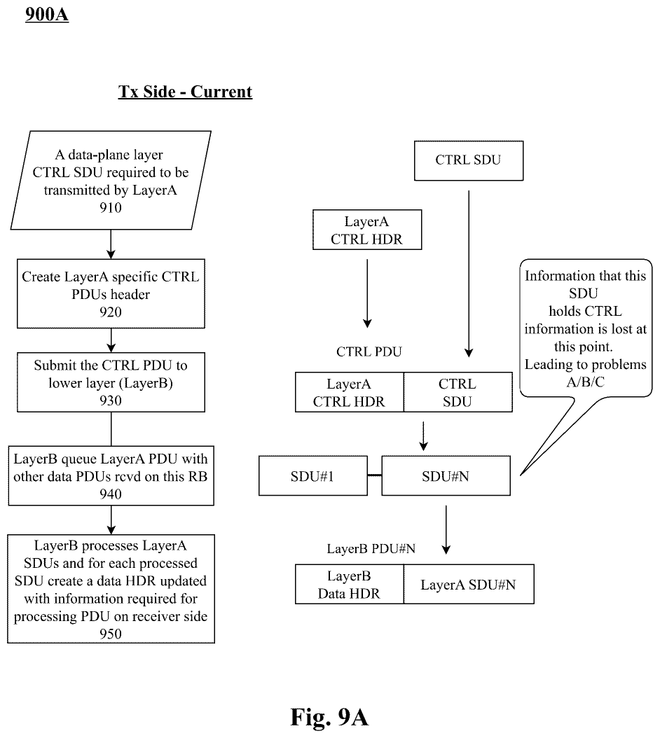

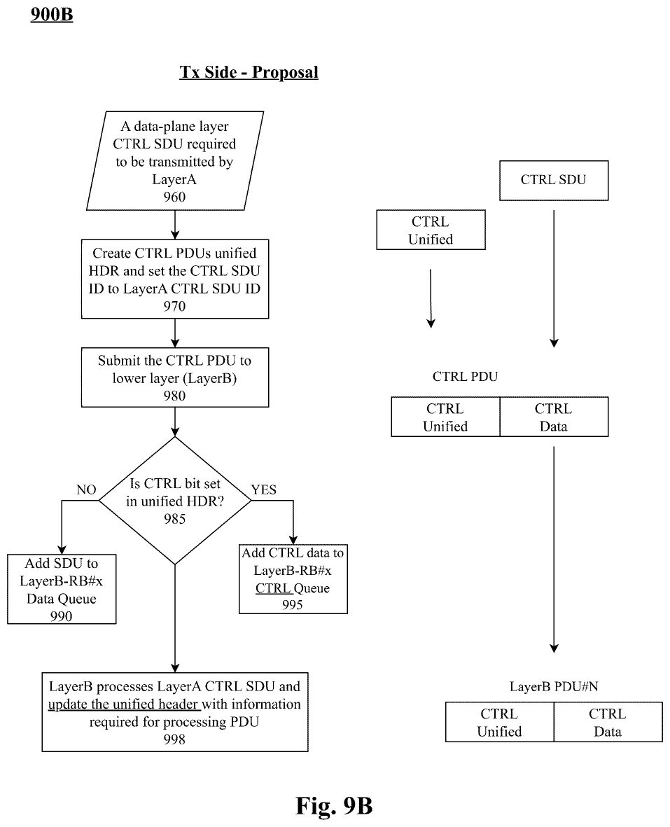

The method of preparation of the CTRL PDU will now be discussed, first from the transmit (Tx) side. FIG. 9A is an example flow diagram of an example current method of preparing an example CTRL PDU according to various example embodiments. First, the current method 900A on the TX will be discussed. In 910, a data-plane layer CTRL SDU is required to be transmitted by Layer A. In 920, a layer A specific CTRL PDUs header is created. The CTRL PDU is submitted to the lower layer (layer B) in 930. Layer B queues the Layer A CTL PDU with other data PDUs received on the radio bearer in 940. At this point, information that this SDU holds (such as CTRL information) may be lost, leading to the issues A/B/C discussed above. In 950, Layer B processes the Layer A SDUS and for each processed PDU, creates a data header updated with information required for processing the PDU on the receiver side.

In contrast, using the proposed novel method implementing a unified control PDU header, the UE serves the CTRL PDU on the same RB on which the SDU was generated. The cellular network or UE maintains a separate queue for the CTRL data, based on which the UE reports to the network the amount of pending CTRL data on a certain RB or group of RBs, and the cellular network or UE prioritizes the serving of CTRL PDUs versus data PDUs. The cellular network or UE may set the CTRL SDU ID in the unified header, where the CTRL SDU ID is unique across all cellular data-plane layers. When an assignment is received, the cellular network or UE may prioritize serving the CTRL SDUs across all RBs versus Data SDUs.

FIG. 9B is an example flow diagram of an example novel method of preparing an example CTRL PDU utilizing a unified CTRL PDU header according to various example embodiments. In method 900B, a data-plane layer CTRL SDU is required to be transmitted by Layer A (960). In 960, a unified header (CTRL Unified) is created for the CTRL PDUs and the CTRL SDU ID is set to Layer A CTRL SDU ID. The CTRL PDU is submitted to the lower layer (layer B) in 980. In 985, a determination is made as to whether the CTRL bit is set in the unified header. If not, the method will add SDU to Layer B-RB #x data queue (990). If so, the method will add CTRL data to Layer B-RB #x CTRL queue (995). In 998, Layer B processes Layer A CTRL SDU and updates the unified header with information required for processing PDU(s) on the receiver side.

To address Issue A described above, where the cellular network is not able to know the number of bytes pending for control SDUs on UE handled by lower layers as Data SDUs, the novel unified header allows for control of the pending amount of data by new buffer status reporting on the Tx side, where the UE reports to the cellular network the amount of pending CTRL data on a certain RB(s), since CTRL PDUs are now identifiable across all layers via the unified header. This is also achievable per layer or even per certain CTRL PDU type.

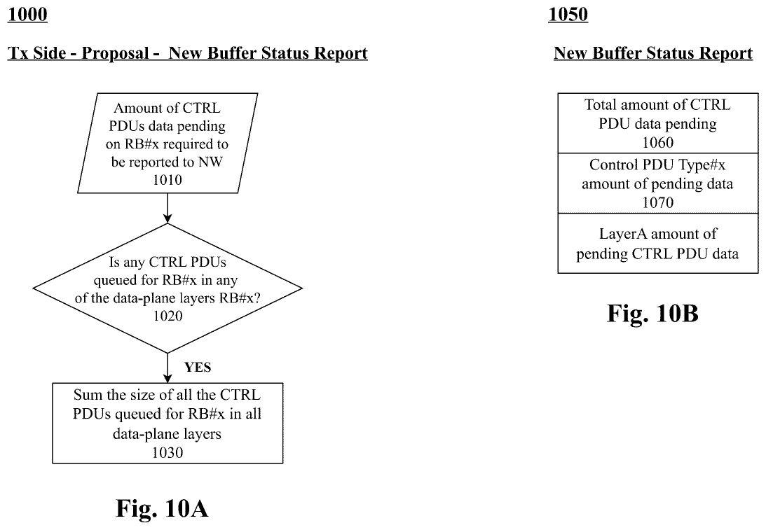

FIG. 10A shows a flow diagram for generating a new example buffer status report according to various example embodiments. The method 1000 for generating a new buffer status report includes determining the amount of CTRL PDUS data pending on RB #x required to be reported to the network (1010). A determination is made as to whether any CTRL PDUs are queued for RB #x in any of the data-plane layers RB #x (1020). If so, the method includes summing the size of all the CTRL PDUs queued for RB #X in all of the data-plane layers (1030).

FIG. 10B shows an example new buffer status report according to various example embodiments. The buffer status report 1050 may include the total amount of CTRL PDU data pending (1060). The buffer status report 1050 may also include the Control PDU Type #x amount of pending data (1070). The buffer status report 1050 may also include the Layer A amount of pending CTRL PDU data (1080).

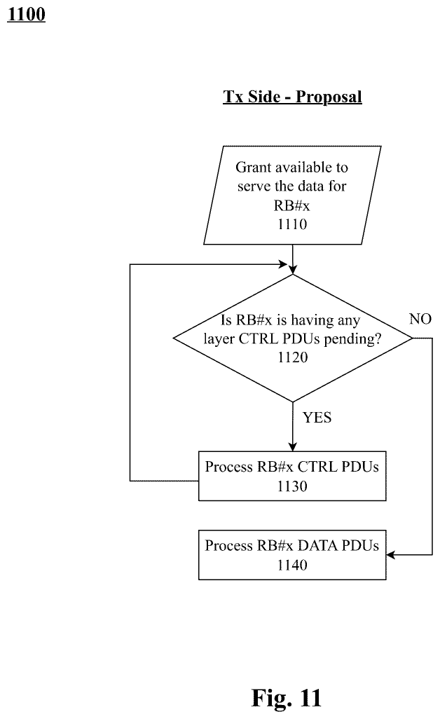

To address Issue B described above, where it is not possible to prioritize CTRL SDUs versus data SDUs of other layers or other RBs, the novel unified header allows for CTRL PDU prioritization on the Tx side. FIG. 11 shows a flow diagram for an example method of prioritizing CTRL PDUs on the Tx side according to various example embodiments. When a grant is available for transferring data from an RB, the cellular network or UE may serve the RB pending CTRL PDUS before serving the RB pending DATA PDUs. Based on the CTRL SDU ID in the unified header, the cellular network or UE may prioritize certain CTRL PDUs over the other CTRL PDUS. For example, the cellular network or UE may prioritize the SDAP CTRL PDUs versus the RLC CTRL PDUs in one embodiment. In method 1100, when a grant is available for transferring data from an RB #x (1110), a determination is made as to whether RB #x has any layer CTRL PDUs pending, based on the CTRL SDU ID in the unified header (1120). If so, the RB #x CTRL PDUs may be processed first (1130). If not, the RB #x data PDUs may be processed (1140).

To address Issue C described above, where the processing of CTRL SDUs may be delayed due to missing data SDUs on lower layers, the novel unified header allows a way to avoid this delay.

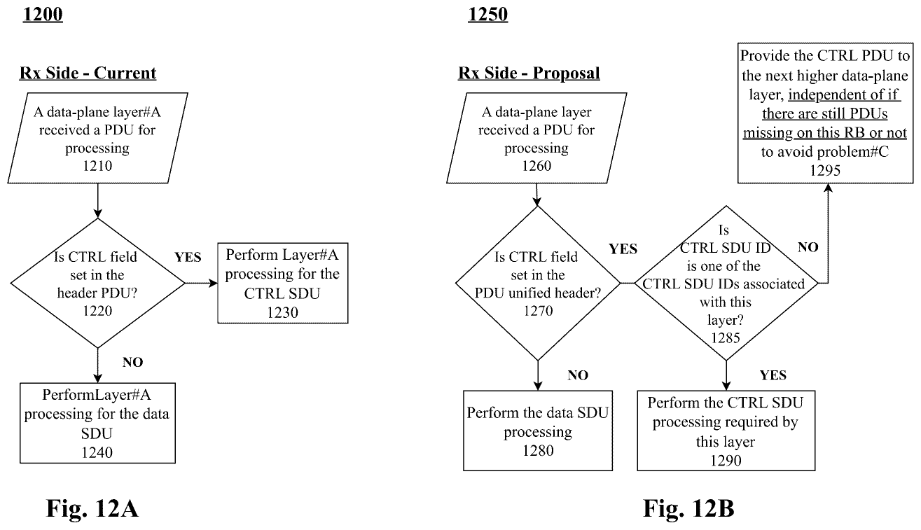

FIG. 12A shows a flow diagram that illustrates an example method of processing CTRL SDUs on the receiver (Rx) side according to various example embodiments. In the current method 1200, a data-plane layer A receives a PDU for processing (1210). A determination is made as to whether the CTRL field is set in the header PDU (1220). If so, Layer #A processing is performed for the CTRL SDU (1230). If not, Layer #A processing is performed for the data SDU (1240). However, if there is missing data SDUs on lower layers, the processing of CTRL SDUs may be delayed.

Using the unified header may help avoid this delay. FIG. 12B shows a flow diagram that illustrates an example method of processing CTRL SDUs on the receiver (Rx) side utilizing a unified header according to various example embodiments. In the novel method 1250, a data-plane layer A receives a PDU for processing (1260). A determination is made as to whether the CTRL field is set in the PDU unified header (1270). If not, then processing for the data SDU may be performed (1280). If the CTRL field is set in the PDU unified header, a determination is made at 1285 as to whether the CTRL SDU ID is one of the CRTL SDU IDs associated with this layer. If so, the CTRL SDU processing required by this layer is performed at 1290. If not, the CTRL PDU is provided to the next higher data-plane layer independent of whether there are still PDUs missing on this RB or not (1295).

In this manner, the unified header allows for the processing of CTRL SDUs even when there is missing data SDUs on lower layers. When a data plane layer receives a PDU and the PDU is tagged in the header as CTRL, the data-plane layer may process the corresponding CTRL SDU inside the PDU if the received Control SDU ID is one of the data-plane layer CTRL SDUs IDs. Otherwise, the PDU shall be passed to the next data-plane higher layer. When a CTRL PDU is received and required to be delivered to the next higher data-plane layer, the cellular network or UE may immediately deliver the CTRL PDU to the next higher data-plane layer independent of whether there are still missing PDUs on this RB or not. This avoids blocking CTRL PDUs processing due to missing data PDUs as explained in Issue C above.

In addition to the unified header described above, a second method may be used on top of, or independently of, the unified header. This second method incorporates the use of a new type of radio bearers referred to as control radio bearers (CRBs). This may be particularly useful in addressing Issue D discussed above, where the CTRL PDUs of a certain data-plane layer may only utilize data-plane services provided by lower layers. By using these novel CRBs on top of the unified headers to address Issue D, provides the ability to apply any cellular data-plane service (independent of which layer is performing this service) on any data-plane CTRL SDU. Accordingly, data-plane services like security protection, ARQ retransmissions or segmentation may be applied on any data-plane layer control SDU (e.g., MAC CEs).

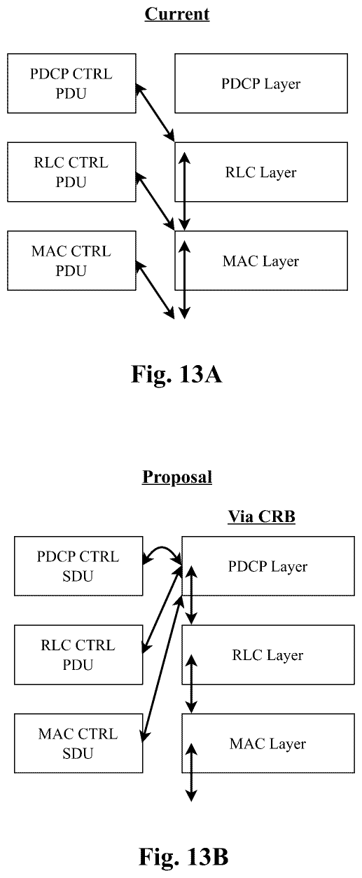

In the current approach, as seen in FIG. 13A, there is no mechanism for applying a cellular data-plane service provided by a higher data-plane layer on a on a CTRL SDU generated by lower data-plane layer. FIG. 13A shows an example of how various data-plane layers handle various types of PDUs according to various example embodiments. For example, currently it is not possible to send an RLC Status PDU that is security protected via PDCP security protection cellular data-plane services. Some large CTRL SDUs may not be segmented (e.g., RLC Status PDUs and MAC CEs).

FIG. 13B shows an example of how various data-plane layers handle various types of PDUs via novel Control Radio Bearers (CRBs) according to various example embodiments. A new type of RB is introduced (CRBs) or it may be piggy backed on a signaling RB. The cellular network configures the UE with one or more Control Radio Bearers, and for each CRB, specifies the CTRL SDUs that shall be transferred via this CRB. For example, the network may configure the UE to send Carrier Aggregation MAC CE via a Control Radio Bearer. The Control Radio Bearer may have the same configuration as other data and signaling Radio Bearers. Accordingly, the CTRL SDUS transfer could be associated with all data-plane services (like security protection, error recovery via protocol like ARQ, etc.). If more than one CRB is being configured, then the CRB identified may be included in the CTRL SDU header. When a cellular UE or network receives a CTRL PDU on a Control Radio Bearer and once all the data-plane layers enabled services for the Control Radio Bearer have been completed, the CTRL SDU is delivered to the data-plane layer owning this CTRL SDU ID. When an assignment is received, the cellular network or UE may prioritize serving the CTRL SDUs across all RBs versus data SDUs.

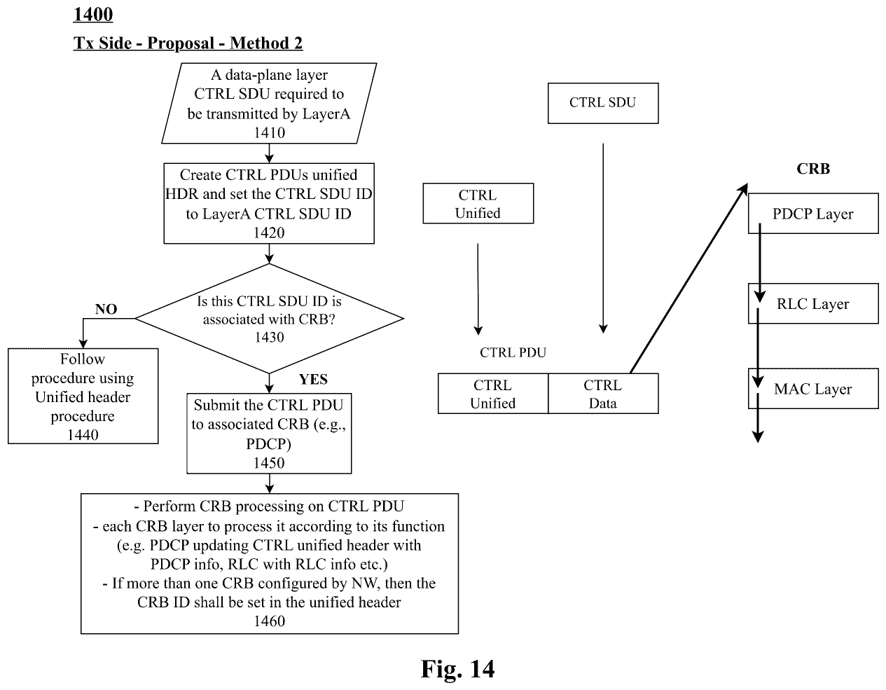

FIG. 14 shows a flow diagram of an example method using example Control Radio Bearers (CRBs) on the Tx side to allow the application of cellular data-plane services provided by a higher data-plane layer on control SDUs generated by a lower data-plane layer according to various example embodiments. In the method 1400, a determination is made that a data-plane layer CTRL SDU is required to be transmitted by Layer A (1410). A unified header is created for the CTRL PDUs and the CTRL SDU ID is set to the Layer A CTRL SDU ID (1420). A check is made to see if this CTRL SDU ID is associated with the CRB (1430). If not, then the procedure using just the unified header as discussed above is followed (1440). If the CTRL SDU ID is associated with the CRB, then the CTRL PDU may be submitted to the associated CRB (e.g., PDCP) (1450). The method includes performing CRB processing on the CTRL PDU, where each CRB layer processes the CTRL PDU according to its function (1460). For example, this may include the PDCP updating the CTRL unified header with PDCP information, the RLC with RLC information, and so on. If more than one CRB is configured by the network, then the CRB ID is set in the unified header.

It is noted that the network may fully determine which CTRL information is to be used and may decide on an individual (e.g., MAC CE) basis whether each step of the above method needs to be performed.

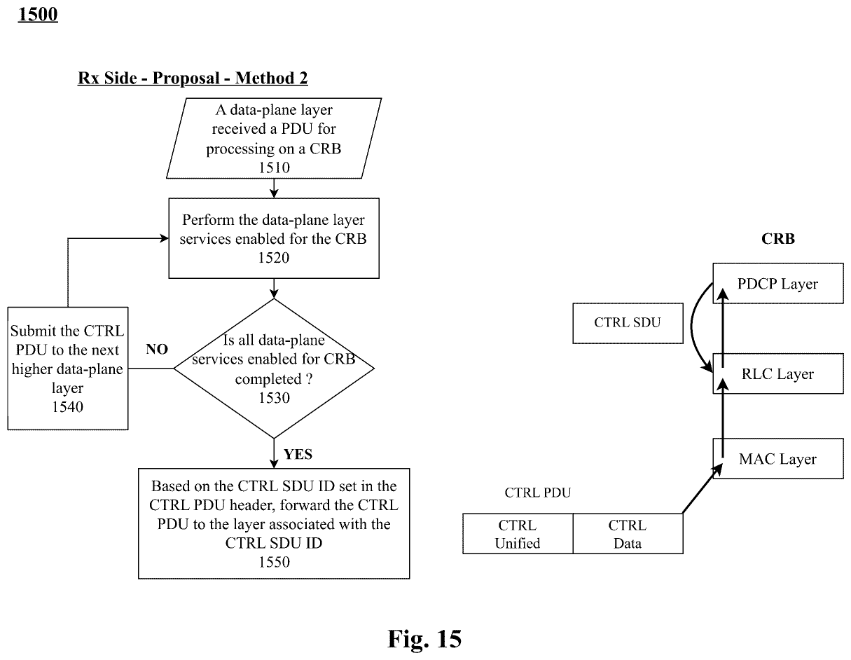

Using the novel CRBs may also provide improved security. In the current known methods, all control PDUs generated by previous layers and below are not secure. FIG. 15 shows a flow diagram of an example method of using example control radio bearers (CRBs) on the receiver (Rx) side to provide increased security for data transmission according to various example embodiments. In method 1500 of FIG. 15, a data-plane layer receives a PDU for processing on a CRB (1510). Data-plane services enabled for the CRB are performed (1520). A determination is made as to whether all data-plane services enabled for the CRB have been completed (1530). If not, then the CTRL PDU is submitted to the next higher data-plane layer (1540). If so, the CTRL PDU is forwarded to the layer associated with the CTRL SDU ID (1550).

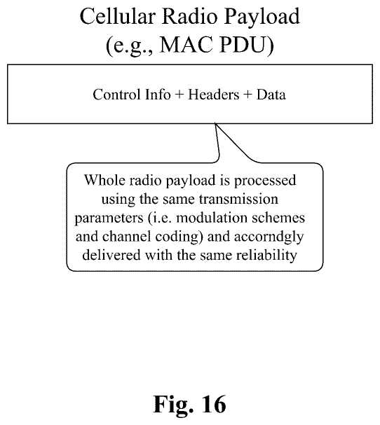

Another approach to providing improved communication services includes the use of novel data-plane layers multi-section payloads. Currently, there is no scheme available to allow a cellular radio payload to be transferred with different transmission parameters. FIG. 16 is a diagram that shows an example cellular radio payload, such as a MAC PDU, according to various example embodiments. When a cellular network or UE transfers a cellular radio payload (e.g., 5G MAC PDU-Transport Block), all the information (e.g., control information, headers, data) in the payload are processed with the same transmission parameters (e.g., Modulation scheme, channel coding rate matching) and accordingly delivered with the same reliability, as seen in FIG. 16. Being able to deliver the cellular radio payload important information (e.g., CTRL information & Headers) with higher reliability would enable the following: early processing of CTRL information (e.g., RLC Status PDUs and MAC CEs); requesting HARQ retransmission for selective parts of payload (e.g., specific code blocks) based on the importance of the data they hold; and/or reducing the number of retransmissions or completely skipping retransmissions, based on the importance of the data in the missing part of payload (that may be derived based on the successfully decoded headers).

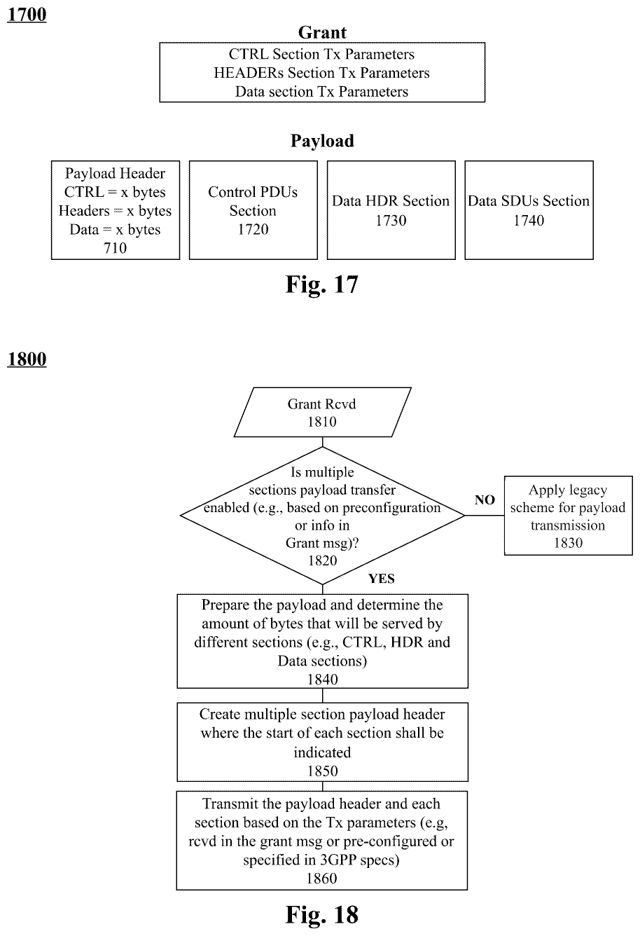

In one example embodiment, a new cellular radio payload having multiple sections is proposed. FIG. 17 shows an example multi-section cellular radio payload according to various example embodiments. For a grant of CTRL Section Tx parameters, HEADERs Section Tx parameters, and Data section Tx parameters, a novel multi-section cellular radio payload 1700 having a payload header 1710 may be composed of more than one section, with a section for control PDUs 1720, a section for headers 1730, and a section for data 1740.

By using the novel multi-section cellular radio payload, each section in the payload could be transmitted with different transmission parameters so the transfer reliability for each section could be controlled separately. Each cellular radio payload would have a header that provides information about the start and end of each section (e.g., it may hold the length of the payload sections). The cellular network configures the UE with the transmission parameters for each section and payload header via one or more of the following: being provided to the UE as a pre-configuration; dynamically received in the grant message; specified in 3GPP specs (e.g., could be limited for certain sections and/or payload header); or a combination of all of the above.

FIG. 18 is a flow diagram of an example method of creating and using a novel multi-section cellular radio payload such that data may be transmitted with different reliability and or priority according to various example embodiments. In the method 1800, once a grant is received (1810), a determination is made as to whether a multiple-section payload transfer is enabled (1820). In one embodiment, this may be based on pre-configuration or on information in the grant message. If the multiple-section payload transfer is not enabled, then the legacy scheme for payload transmission may be applied (1830). If the multiple-section payload transfer is enabled, the payload is prepared and the amount of bytes that will be served by different sections (e.g., CTRL, header, and data) is determined (1840). A multiple-section payload header is created where the start of each section is indicated (1850). In 1860, the payload header and each section may be transmitted based on the Tx parameters (e.g., received in the grant message or pre-configured or specified in the 3GPP specifications).

On the receiver side, the cellular network or UE may immediately process the sections that are successfully received, independent of the remaining sections' status. The UE may indicate via HARQ feedback which sections are successfully received. The cellular network may indicate in the assignment message (e.g., DCI) which section to be re-transmitted.

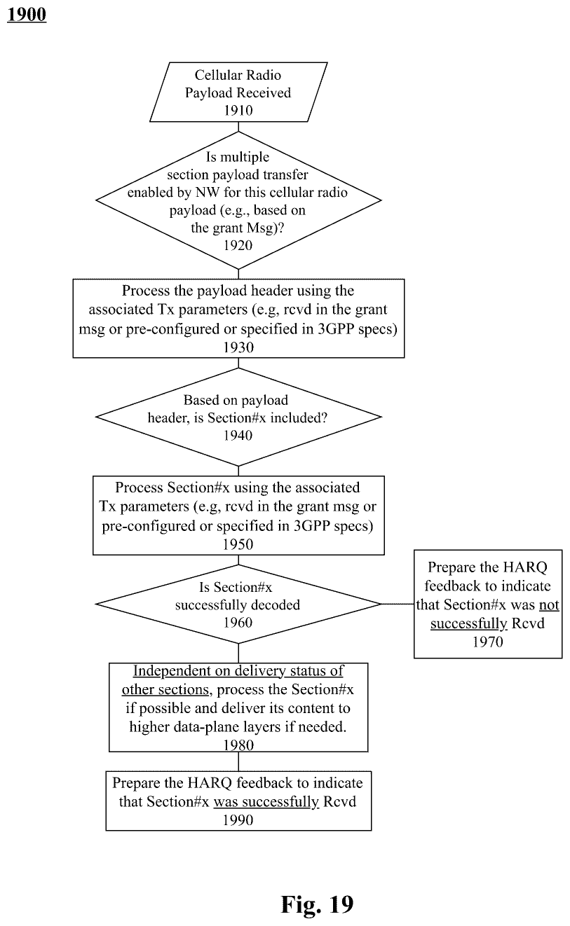

FIG. 19 is a flow diagram that illustrates an example method of processing a received data transfer of a novel multi-section cellular radio payload according to various example embodiments. In method 1900, once the multi-section cellular radio payload is received (1910), a determination is made as to whether the multiple section payload transfer is enabled by the network for this cellular radio payload (e.g., based on the grant message) (1920). If so, the payload header is then processed using the associated Tx parameters (e.g., received in the grant message or pre-configured or specified in the 3GGP specifications) (1930). A check is made to see if the Section #x is included, based on the payload header (1940). If so, the section #x is processed using the associated Tx parameters (1950). In 1960, a determination is made as to whether the section #x was successfully decoded. If not, HARQ feedback is generated to indicate that the Section #x was not successfully received (1970). If the section #x was successfully decoded, then the section #x is processed, independent of the delivery status of other sections if possible, and the content is delivered to the higher data-plane layers if needed (1980). HARQ feedback is generated to indicate that the Section #x was successfully received (1990).

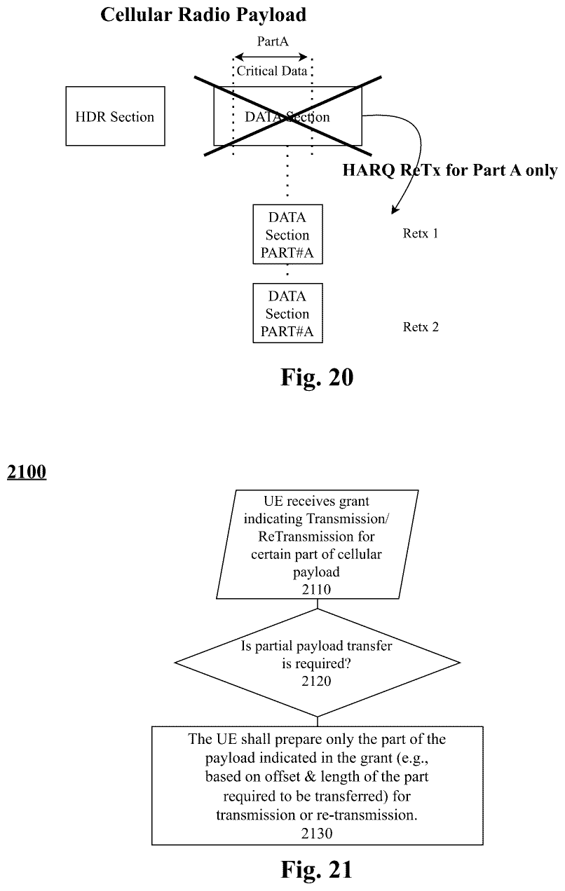

When using the multi-section payload discussed above, this also allows for re-transmission of only certain parts of the cellular payload based on the successfully scheduled section(s). FIG. 20 shows a diagram illustrating an example method of only certain parts of an example cellular payload needing to be retransmitted based on the successfully scheduled section(s) according to various example embodiments. Referring to FIG. 20, the cellular network may select transmissions or retransmissions (e.g., HARQ re-transmissions) for only certain parts of the cellular payload (e.g., starting from MAC PDU byte offset x with length y bytes) based on the information received in the successfully delivered sections of the payload.

If the Headers section was successfully received and only certain part of the data section has data for high priority radio bearers, the cellular network may request the UE re-transfer (e.g., HARQ re-transmission) only for the part of the data section in the cellular data payload that is associated with the high priority Radio Bearers. FIG. 21 shows a flow diagram for an example method for retransmitting only certain data in an example cellular radio payload that is associated with high priority Radio Bearers according to various example embodiments. Referring to FIG. 21, in the example method 2100, a UE receives a grant indicating transmission/retransmission for certain part(s) of the cellular payload (2110). In 2120, a check is made to see if partial payload transfer is required. If so, the UE shall prepare only the part of the payload indicated in the grant (e.g., based on offset and length of the part required to be transmitted) for transmission or re-transmission (2130).

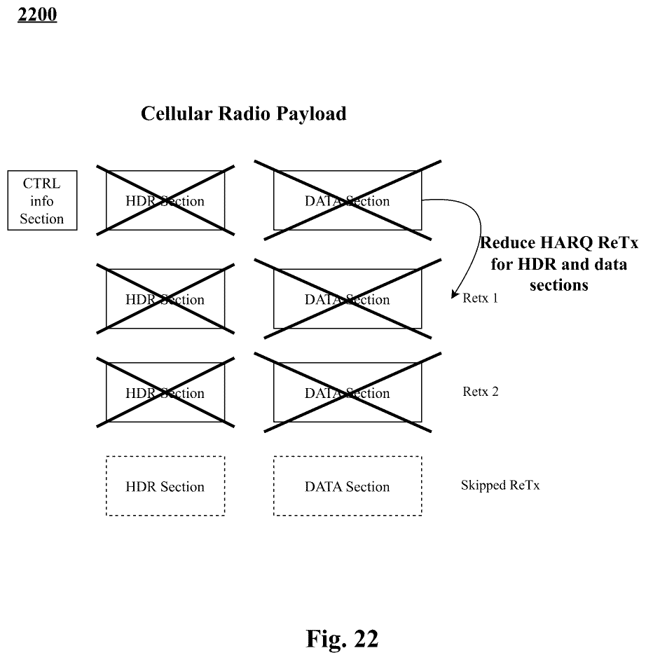

In addition, the use of the multi-section payload may also enable dynamic control of the cellular network re-transmissions. For example, FIG. 22 shows a diagram that illustrates how an example network may dynamically skip or reduce the number of retransmissions for an example cellular radio payload based on information in successfully delivered sections of the cellular radio payload according to various example embodiments. Referring to FIG. 22, the cellular network may dynamically skip or reduce the number of retransmissions (e.g., HARQ re-transmission) for a cellular radio payload based on the information in the successfully delivered sections (whether received in HARQ feedback in the downlink (DL) or from received parts of the radio payload in the UL). For example, if the CTRL section was successfully delivered, then the cellular network may reduce the number of HARQ re-transmissions for the remaining sections. If the Headers section was successfully delivered and the Radio Bearers having data in the data section are low priority, then the cellular network may skip or reduce the number of HARQ retransmissions for this cellular payload.

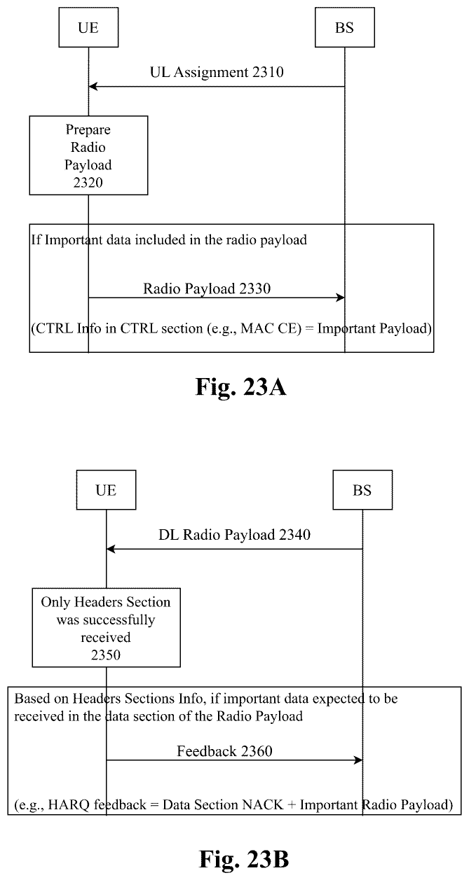

In addition, the use of the multi-section payload may also enable dynamic control of the cellular UE re-transmissions. For example, FIG. 23A shows a diagram that illustrates how an example UE may indicate to a network the importance of a certain radio payload for the uplink transmission according to various example embodiments. Referring to FIG. 23A, upon receiving an UL assignment from a base station (2310), a cellular UE may prepare the radio payload (2320) and indicate to the cellular network the importance of a certain radio payload when transmitting the radio payload (2330) (e.g., if data included in the radio payload is important based on application information or protocol state information like PDCP discard status for a certain PDU included in the payload) to allow the network to dynamically control the radio payload retransmissions (e.g., HARQ reTx skip/increase/reduce). In the UL, the cellular UE may indicate this information in the CTRL section of the radio payload. For example, a MAC CE may be used to indicate the importance of the radio payload in one embodiment.

FIG. 23B is an example flow diagram that illustrates how an example UE may indicate to a network the importance of a certain radio payload for the downlink transmission according to various example embodiments. In the DL, based on the successfully received sections (Data Headers section), the cellular UE indicates to the network in the radio payload feedback (HARQ feedback) the importance of the radio payload. Referring to FIG. 23B, when the UE receives a DL radio payload from the base station (2340), if only the headers section was successfully received (2350), the UE may then send feedback to the base station indicating whether important data is expected to be received in the data section of the radio payload based on the headers section information (2360).

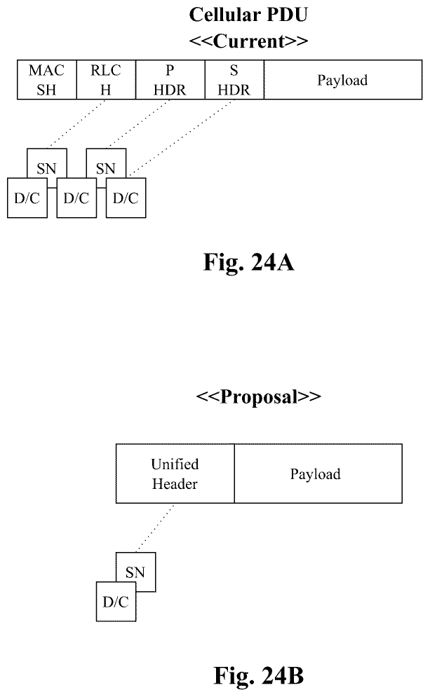

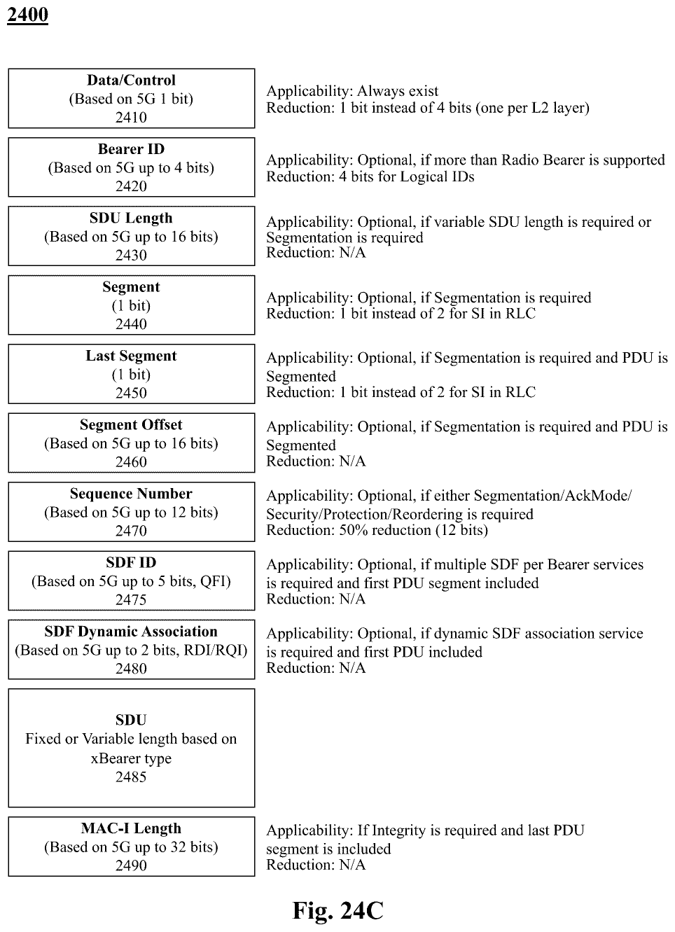

A unified data-plane layers header may also be used for user plane or signaling data in addition to control data. Currently, the cellular network or UE may be duplicating header fields for data-plane services in different layers. FIG. 24A shows an example cellular PDU where header fields are duplicated for data-plane services in different layers according to various example embodiments. In this approach, header fields across cellular data-plane layers are not re-usable, leading to having redundant header fields to serve a single cellular SDU. For example, the PDCP and RLC layers may each have its own sequence number. Further, every data-plane layer may have a Data/Control header field.

To address this issue, a unified header is proposed that is common for all the cellular data-plane layers. FIG. 24B shows an example unified header that is common across all cellular data-plane layer according to various example embodiments. Referring to FIG. 24B, the cellular UE and network use for an SDU header only a single Data/Control field that is used by all cellular data-plane layers. Likewise, the cellular UE and network use a single header field (e.g., sequence number field) to perform different cellular data services that could be performed by different cellular data-plane layers. For example, the cellular UE and network may use per SDU a single header field (e.g., SN) to perform the following data-plane services: cellular SDUs security protection (e.g., ciphering and integrity protection); ordered delivery of SDUs; segmentation of SDUs; error recovery (e.g., via ARQ); duplicate detection; data-recovery after connection re-establishment; and/or any other cellular services that may require one or more SNs (e.g., security protection in MAC layer). Each cellular data-plane layer provides the payload to the next layer composed from two separate parts—the processed SDU and the unified header for that SDU, where the SDU unified header maintains all information required for processing a cellular data-plane payload across all cellular data-plane layers.

The above-described methods and techniques may also apply to data PDUs. FIG. 24C shows the various fields of an example unified header 2400 for data PDUs according to various example embodiments. The unified control data PDU header may have the following information: Data/Control field 2410, set to DATA. In one embodiment, the data/control field 810 may be based on a 5G one (1) bit. The unified control PDU header may also include an optional Bearer ID field 2420 to identify the specific Radio Bearer (RB) if there are multiple RBs. In one example embodiment, the Bearer ID field 2420 may be up to four (4) bits. If the data SDU has a variable length, or if segmentation is required, then a Data SDU length field 2430 may be included. In one embodiment, the Data SDU length field 2430 may be up to sixteen (16) bits.

If the Data SDU could be segmented, then the unified data PDU header may also include segmentation header fields, such as: Segment ID field 2440, which may be one (1) bit in certain embodiments; Last Segment field 2450, which may be one (1) bit in certain embodiments; and Segment Offset field 2460, which may be up to 16 bits in one embodiment. If the Data SDU requires any data-plane services such as Security Protection/Order Delivery/Segmentation/Error Recovery (e.g., via ARQ)/Duplication Detection, then a sequence number field 2470 may be included, which may be up to 12 bits in one embodiment. The unified data PDU header may also include an SDF ID field 2475 of up to five (5) bits in some embodiments if multiple SDFs per bearer service are required and the first PDU segment is included. An SDF Dynamic Association Field 2480 of up to two (2) bits in some embodiments may also be included if dynamic SDF Association service is required and the first PDU is included. Fields 2420-2480 may be optional fields.

The unified data PDU header also includes the data SDU field 2485, which may have a fixed or variable length based on the RB type. A MAC-I Length field 2490 may also be included if integrity is required and the last PDU segment is included, and may constitute up to thirty-two (32) bits.

In summary, the unified headers and novel control and data sections of the transport block disclosed herein may provide numerous advantages. For example, header sizes may be optimized, as there is no wasting of bits due to duplication of information of padding for octet alignment. In addition, control PDUs, unified SDU headers and SDUs could be separately processed and transferred. Also, control SDUs could be prioritized during scheduling (e.g., MAC layer logical channel prioritization) since they are not encapsulated any longer within lower layer PDUs. For example, currently the PDCP Status control SDU is being encapsulated within RLC PDU. Accordingly, the MAC layer cannot prioritize during logical channel prioritization procedure since the MAC is not aware whether the RLC PDU contains control SDU or data SDU. Further, the compact collection of headers allows for hardware processing optimized in encoding and decoding. Currently in NR or LTE, in order to know the next layer's header location to start decoding, the decoding and processing of the previous layer's header is first required. That would no longer be necessary using the techniques described herein.

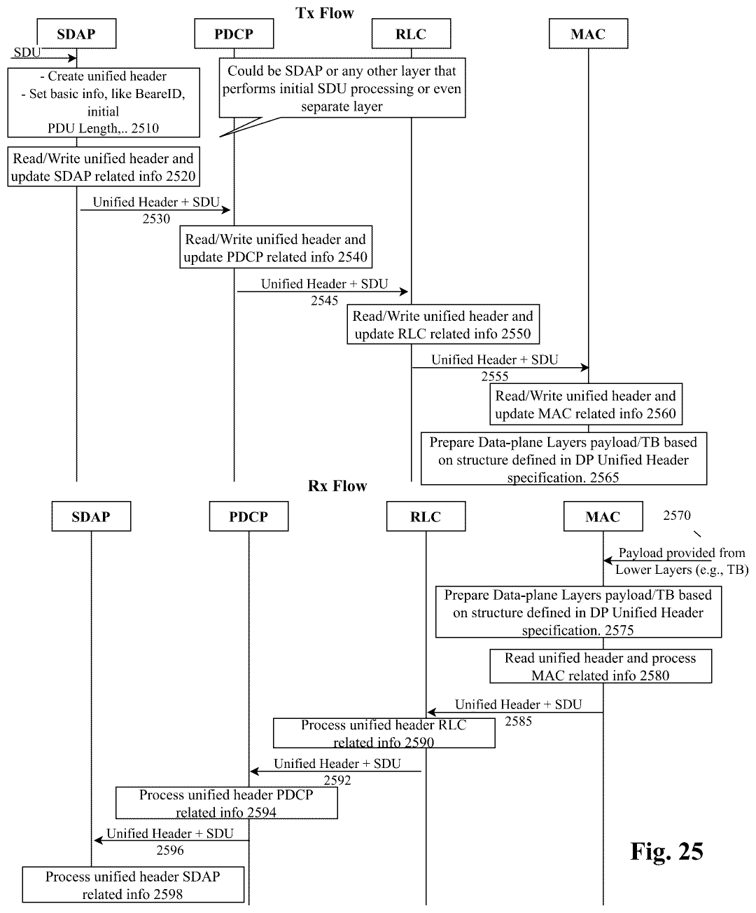

FIG. 25 is a flow diagram that illustrates an example method using 5G data-plane layers with a unified data-plane header according to various example embodiments. The unified data-plane header could be specified in a dedicated 3GPP specifications, in addition on how the data-plane layers payload that is provided to lower layers should be structured.

Referring to the method 2500 in FIG. 25, in the Tx direction, per SDU, creation of the unified header (2510) is done by the first layer serving the SDU (may be SDAP, PDPCP or RLC or even MAC, based on Radio Bearer serving requirements) where different fields (e.g., Bearer ID, SN, etc.) could be initialized based on the Radio Bearer configured data-plane services. In one embodiment this may be the SDAP or any other layer that performs initial SDU processing or even separate layer. The unified PDU header is passed from each layer to the following layer and each layer may read/write/update its relevant information in the header (2520, 2530, 2540, 2545, 2550, 2555, 2560). Finally, the layer prepares the data-plane payload and transport block to be provided to the lower layer and organizes the payload (i.e., location of SDU headers and SDUs in the payload) based on requirements specified in the DP Unified header specification (2565).

In the Rx direction, a payload is provided from the lower layers (e.g., a transport block) (2570) to a first layer. The data-plane layers payload/TB is processed by the first layer based on structure defined in the DP Unified Header specification (2575). For example, the MAC layer may perform the extraction of the data-plane SDUs and their corresponding unified headers based on requirements specified in the DP unified header specification (2580). Then while providing the SDU to next layer, the corresponding SDU unified header is also provided (2585). Each layer (RLC, PDCP, SDAP) processes its related information in the unified header (2590, 2592, 2594, 2596, 2598).

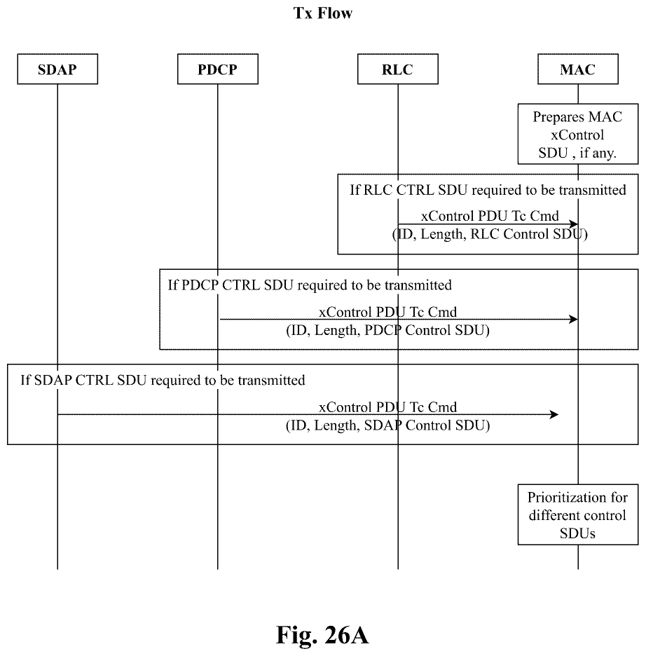

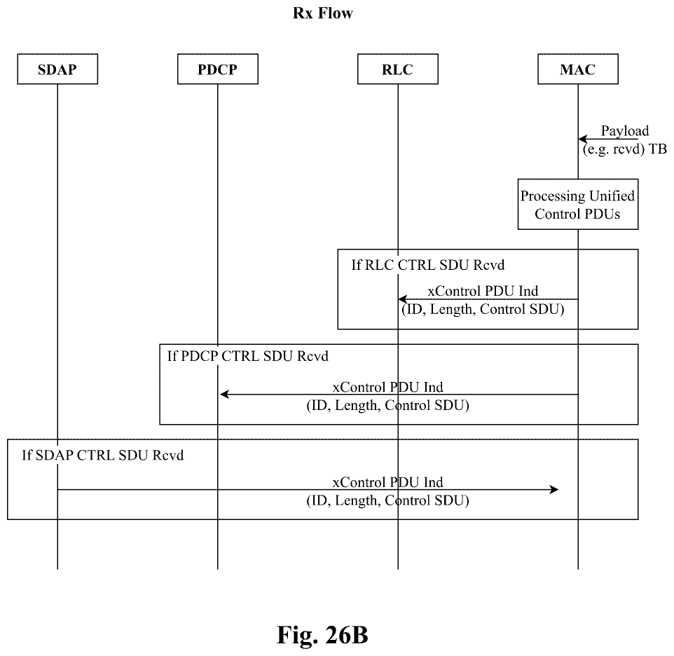

FIGS. 26A and 26B show the Tx and Rx flows using the unified control PDUs header.

By using the methods and devices with the unified cellular data-plane headers and the novel control and data sections in the transport block disclosed herein, improved wireless communications may be realized.

### Examples

In a first example, a method, comprising receiving, based on signals from another apparatus, a transport block comprising a control section, a headers section, and one or more data sections, the transport block having a unified data-plane header and processing the transport block based on the unified data-plane header.

In a second example, the method of the first example, wherein the unified data-plane header comprises a data/control field set to CTRL.

In a third example, the method of the first example, wherein the unified data-plane header comprises a control Service Data Unit Identifier (CTRL SDU ID) field and/or a data SDU ID set to a corresponding data-plane layer CTRL SDU ID and/or data SDU ID that is unique across all data-plane layers.

In a fourth example, the method of the first example, wherein the unified data-plane header comprises a header length field if a CTRL SDU and/or data SDU has variable length.

In a fifth example, the method of the first example, wherein the unified data-plane header comprises a sequence number field.

In a sixth example, the method of the fifth example, wherein the unified data-plane header comprises one or more segmentation header fields, the segmentation header fields comprising one or more of segment identifier field, last segment field, and segment offset field.

In a seventh example, the method of the first example, wherein the transport block comprises data-plane layers control Service Data Units (SDUs), and the data-plane layers control SDUs are configured to be served via a radio bearer for which the control SDU is generated.

In an eighth example, the method of the first example, wherein the transport block comprises data-plane layers control Service Data Units (SDUs), and the data-plane layers control SDUs are configured to be served via a separate and different radio bearer than a radio bearer for which the control SDU is generated.

In a ninth example, the method of the first example, wherein a separate queue is maintained for control data in a radio bearer.

In a tenth example, the method of the ninth example, further comprising transmitting a report of an amount of pending control data on a certain radio bearer or group of radio bearers.

In an eleventh example, the method of the ninth example, further comprising transmitting a report of an amount of pending data on a certain control Service Data Unit (CTRL SDU) type.

In a twelfth example, the method of the ninth example, wherein processing one or more of a set of control Protocol Data Units (CTRL PDUs) is prioritized over other CTRL PDUs of the set of CTRL PDUS.

In a thirteenth example, the method of the ninth example, wherein processing control Protocol Data Units (CTRL PDUs) is prioritized over data PDUs.

In a fourteenth example, the method of the first example, further comprising determining from the transport block that a data-plane layer control Service Data Unit (CTRL SDU) is to be transmitted by a first layer, creating a control Protocol Data Unit (CTRL PDU) unified header and set a control Service Data Unit Identifier (CTRL SDU ID) to be a CTRL SDU ID for the first layer and submitting the CTRL PDU unified header to a second layer lower than the first layer.

In a fifteenth example, the method of the fourteenth example, further comprising determining if a control (CTRL) bit is set in the unified data-plane header, adding the CTRL SDU to a data queue for a radio bearer for the second layer if the CTRL bit is not set in the unified data-plane header and adding the CTRL data to a control queue for a radio bearer for the second layer if the CTRL bit is set in the unified data-plane header.

In a sixteenth example, the method of the fifteenth example, wherein the second layer processes the first layer CTRL SDUs and updates the unified data-plane header with information to process PDUs on a receiver side.

In a seventeenth example, the method of the first example, further comprising determining from the transport block that a data-plane layer Protocol Data Unit (PDU) is to be transmitted by a first layer, determining whether a control (CTRL) bit is set in the unified data-plane header, when the CTRL bit is not set, processing data Service Data Units (SDUs) within the PDU, when the CTRL bit is set: determining if a control Service Data Unit Identifier (CTRL SDU ID) in the PDU is one of the CTRL SDU IDs associated with the first layer, performing control SDU processing used by the first layer if the CTRL SDU ID is one of the CTRL SDU IDs associated with the first layer and providing the CTRL SDU to a next higher data-plane layer if the CTRL SDU ID is not one of the CTRL SDU IDS associated with the first layer, independent of whether PDUs are missing on a radio bearer associated with the first layer.

In an eighteenth example, the method of the first example, further comprising receiving configuration information from a network, the configuration information comprising one or more control radio bearers (CRBs) and for each CRB, information specifying which control Service Data Units (SDUs) are to be transferred via that particular CRB.

In a nineteenth example, the method of the eighteenth example, further comprising performing a data-plane service on a CTRL SDU, independent of which data-plane layer generated the CTRL SDU.

In a twentieth example, the method of the eighteenth example, wherein if more than one CRB is configured, a CRB identifier (CRB ID) is included in a header for a CTRL SDU.

In a twenty first example, the method of the eighteenth example, wherein, when a CTRL SDU is received on a CRB, the method further comprises delivering the CTRL SDU to a data-plane layer owning a CTRL SDU ID associated with the CTRL SDU once all data-plane layers enabled services have been completed for the CRB.

In a twenty second example, the method of the eighteenth example, wherein processing control Protocol Data Units (CTRL PDUs) from the one or more CRBs is prioritized over data PDUs across all radio bearers.

In a twenty third example, the method of the eighteenth example, wherein, when a CTRL SDU having a CTRL SDU identifier (ID) on a CRB is received, the method further comprises determining that a data-plane layer control Service Data Unit (CTRL SDU) is to be transmitted by a first layer, creating a control Protocol Data Units (CTRL PDUs) unified header and set a control Service Data Unit Identifier (CTRL SDU ID) to be a CTRL SDU ID for the first layer, determining whether the CTRL SDU ID for the first layer is associated with the CRB and, when the CTRL SDU ID is associated with the CRB, submitting the CTRL PDU to the associated CRB and performing CRB processing on the CTRL PDU, wherein each CRB layer processes the CTRL PDU according to its respective function.

In a twenty fourth example, the method of the eighteenth example, wherein if the processing circuitry receives a Protocol Data Unit (PDU) on a CRB for a first layer, the method further comprises performing the data-plane layer services for the CRB, determining whether all data-plane services enabled for the CRB have been completed, when all data-plane services enabled for the CRB have not been completed, submitting the CTRL PDU to a second layer that is higher than the first layer and, when all data-plane services enabled for the CRB have been completed, forwarding the CTRL PDU to a layer associated with a CTRL SDU identifier (ID) set in the CTRL PDU header.

In a twenty fifth example, the method of the first example, wherein a single sequence number field is used in the unified data-plane header to perform different cellular data services performed by different cellular data-plane layers.

In a twenty sixth example, a processor configured to perform any of the methods of the first through twenty fifth examples.

In a twenty seventh example, a user equipment or a base station configured to perform any of the methods of the first through twenty fifth examples.

In a twenty eighth example, a method comprising receiving, based on signals from another apparatus, a cellular radio payload comprising a section for control Protocol Data Units (PDUs) section, a headers section, and one or more data sections, wherein the cellular radio payload includes a header that provides information associated with a start and end of each section, wherein each section in the cellular radio payload is to be transmitted with different transmission parameters to separately control a reliability of a transfer for each section and processing the cellular radio payload based on the information in the header.

In a twenty ninth example, the method of the twenty eighth example, further comprising receiving configuration information from a network, the configuration information including transmission parameters for each section and the header.

In a thirtieth example, the method of the twenty ninth example, wherein the configuration information is preconfigured, dynamically received in a grant message, specified in 3GPP specifications, or a combination thereof.

In a thirty first example, the method of the twenty eighth example, wherein any of the control sections, headers sections, and/or one or more data sections that are successfully received independent of a status of any of the other sections are immediately processed and delivered to a higher layer.

In a thirty second example, the method of the twenty eighth example, further comprising to indicating to the another apparatus, via Hybrid Automatic Repeat Request (HARQ) feedback, which sections have been successfully received.

In a thirty third example, the method of the twenty eighth example, further comprising determining whether multiple-section payload transfer is enabled for the cellular radio payload, processing the header using the associated transmission parameters, determining based on the header whether a first section of the control section, headers section, and one or more data sections is included in the cellular radio payload, processing the first section using the associated transmission parameter, determining whether the first section was successfully decoded, when the first section was not successfully decoded, preparing Hybrid Automatic Repeat Request (HARQ) feedback to indicate that the first section was not successful received, when the first section was successfully decoded, processing the first section independent of a delivery status of any other section and deliver content of the first section to a higher data-plane layer and preparing HARQ feedback to indicate that the first section was successfully received.

In a thirty fourth example, the method of the twenty eighth example, further comprising receiving a grant from a network, wherein the grant indicates transmission or re-transmission for a part of the cellular radio payload, determining whether partial radio cellular payload is used based on the grant and processing only the part of the radio cellular payload indicated in the grant.

In a thirty fifth example, the method of the thirty fourth example, further comprising processing only the part of the radio cellular payload indicated in the grant based on an offset and a length of the part to be transferred for transmission or re-transmission.

In a thirty sixth example, the method of the thirty fourth example, wherein a number of re-transmissions are reduced or eliminated for the cellular radio payload based on information in successfully received sections.

In a thirty seventh example, the method of the thirty sixth example, wherein the number of re-transmissions is reduced or eliminated if the control section was successfully received.

In a thirty eighth example, the method of the thirty sixth example, wherein the number of re-transmissions is reduced or eliminated if the headers section was successfully received and radio bearers having data in the one or more data sections are low priority.

In a thirty ninth example, the method of the twenty eighth example, further comprising transmitting an indication to the another apparatus of an importance level of a particular cellular radio payload.

In a fortieth example, the method of the twenty eighth example, wherein, for an uplink transmission, the indication is included in a control section of the cellular radio payload in a Medium Access Control Element (MAC-CE).

In a forty first example, the method of the twenty eighth example, wherein, for a downlink transmission, the method further comprises receiving an indication from the another apparatus of an importance level of a particular cellular radio payload.

In a forty second example, the method of the forty first example, wherein the indication of the importance level of the particular cellular radio payload is transmitted based on successfully received sections and wherein the indication is included in Hybrid Automatic Repeat Request (HARQ) feedback.

In a forty third example, a processor configured to perform any of the methods of the twenty eighth through forty second examples.

In a forty fourth example, a user equipment or a base station configured to perform any of the methods of the twenty eighth through forty second examples.

In a forty fifth example, a method, comprising receiving, based on signals from another apparatus, a transport block comprising a control section, a headers section, and one or more data sections, the transport block having a unified data-plane header that is common for all cellular data-plane layers, wherein the unified data-plane header includes a single data/control field that is used by all cellular data-plane layers and processing the transport block based on the unified data-plane header.

In a forty sixth example, the method of the forty fifth example, wherein a single sequence number field in the unified data-plane header is used to perform different cellular data services performed by different cellular data-plane layers.

In a forty seventh example, the method of the forty fifth example, wherein the unified data-plane header is for a data SDU and wherein each field in the unified data-plane header is configured to be reused by other data-plane layers for their own provided data-plane services.

In a forty eighth example, a processor configured to perform any of the methods of the forty fifth through forty seventh examples.

In a forty ninth example, a user equipment or a base station configured to perform any of the methods of the forty fifth through forty seventh examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as ios, Android, etc. The example embodiments described above may be embodied as a program containing lines of code stored on a non-transitory computer readable storage medium that, when compiled, may be executed on a processor or microprocessor.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICS. In other embodiments, the present invention may be realized using one or more programmable hardware elements such as FPGAS.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus comprising processing circuitry configured to:
receive, based on signals from another apparatus, a transport block comprising a control section, a headers section, and one or more data sections, the transport block having a unified data-plane header; and
process the transport block based on the unified data-plane header.

2. The apparatus of claim 1, wherein the unified data-plane header comprises a data/control field set to CTRL.

3. The apparatus of claim 1, wherein the unified data-plane header comprises a control Service Data Unit Identifier (CTRL SDU ID) field and/or a data SDU ID set to a corresponding data-plane layer CTRL SDU ID and/or data SDU ID that is unique across all data-plane layers.

4. The apparatus of claim 1, wherein the unified data-plane header comprises a header length field if a CTRL SDU and/or data SDU has variable length.

5. The apparatus of claim 1, wherein the unified data-plane header comprises a sequence number field.

6. The apparatus of claim 2, wherein the unified data-plane header comprises one or more segmentation header fields, the segmentation header fields comprising one or more of segment identifier field, last segment field, and segment offset field.

7. The apparatus of claim 1, wherein the transport block comprises data-plane layers control Service Data Units (SDUs), and the data-plane layers control SDUs are configured to be served via a radio bearer for which the control SDU is generated.

8. The apparatus of claim 1, wherein the transport block comprises data-plane layers control Service Data Units (SDUs), and the data-plane layers control SDUs are configured to be served via a separate and different radio bearer than a radio bearer for which the control SDU is generated.

9. The apparatus of claim 1, wherein the processing circuitry is configured to maintain a separate queue for control data in a radio bearer.

10. The apparatus of claim 9, wherein the processing circuitry is configured to cause transceiver circuitry to transmit a report of an amount of pending control data on a certain radio bearer or group of radio bearers.

11. The apparatus of claim 9, wherein the processing circuitry is configured to cause transceiver circuitry to transmit a report of an amount of pending data on a certain control Service Data Unit (CTRL SDU) type.

12. The apparatus of claim 9, wherein the processing circuitry is configured to prioritize processing one or more of a set of control Protocol Data Units (CTRL PDUs) over other CTRL PDUs of the set of CTRL PDUS.

13. The apparatus of claim 9, wherein the processing circuitry is configured to prioritize processing control Protocol Data Units (CTRL PDUS) versus data PDUS.

14. The apparatus of claim 1, wherein the processing circuitry is configured to:
determine from the transport block that a data-plane layer control Service Data Unit (CTRL SDU) is to be transmitted by a first layer;
create a control Protocol Data Unit (CTRL PDU) unified header and set a control Service Data Unit Identifier (CTRL SDU ID) to be a CTRL SDU ID for the first layer; and
submit the CTRL PDU unified header to a second layer lower than the first layer.

15. The apparatus of claim 14, wherein the processing circuitry is configured to:
determine if a control (CTRL) bit is set in the unified data-plane header;
add the CTRL SDU to a data queue for a radio bearer for the second layer if the CTRL bit is not set in the unified data-plane header; and
add the CTRL data to a control queue for a radio bearer for the second layer if the CTRL bit is set in the unified data-plane header.

16. The apparatus of claim 15, wherein the second layer processes the first layer CTRL SDUs and updates the unified data-plane header with information to process PDUs on a receiver side.

17. The apparatus of claim 1, wherein the processing circuitry is configured to:
determine from the transport block that a data-plane layer Protocol Data Unit (PDU) is to be transmitted by a first layer;
determine whether a control (CTRL) bit is set in the unified data-plane header;
when the CTRL bit is not set, process data Service Data Units (SDUs) within the PDU;
when the CTRL bit is set:
determine if a control Service Data Unit Identifier (CTRL SDU ID) in the PDU is one of the CTRL SDU IDS associated with the first layer;
perform control SDU processing used by the first layer if the CTRL SDU ID is one of the CTRL SDU IDS associated with the first layer; and
provide the CTRL SDU to a next higher data-plane layer if the CTRL SDU ID is not one of the CTRL SDU IDS associated with the first layer, independent of whether PDUs are missing on a radio bearer associated with the first layer.

18. The apparatus of claim 1, wherein the processing circuitry is configured to receive configuration information from a network, the configuration information comprising one or more control radio bearers (CRBs) and for each CRB, information specifying which control Service Data Units (SDUs) are to be transferred via that particular CRB.

19. The apparatus of claim 18, wherein the processing circuitry is configured to perform a data-plane service on a CTRL SDU, independent of which data-plane layer generated the CTRL SDU.

20. The apparatus of claim 18, wherein if more than one CRB is configured, a CRB identifier (CRB ID) is included in a header for a CTRL SDU.
